(19) United States
(12) Patent Application Publication
(10) Pub. No.: US 2026/0269489 A1
(43) Pub. Date: Sep. 10, 2026

(54) STREETLIGHT COMPRISING TWO ANTENNA MODULES ARRANGED IN A V-SHAPED CONFIGURATION

(71) Applicant: SIGNIFY HOLDING B.V., EINDHOVEN (NL)

(72) Inventors: TIES VAN BOMMEL, HORST (NL); GUIDO THEO MARIA LAMERICHS, HOESELT (BE); NOUD JOHANNES FLEUREN, BAARLO (NL); RONALD JOHANNES GELTEN, GELDRIOP (NL)

(21) Appl. No.: 19/165,216

(22) PCT Filed: Mar. 11, 2024
(86) PCT No.: PCT/EP2024/056370

§ 371 Date: Sep. 15, 2025

(30) Foreign Application Priority Data
Mar. 16, 2023 (EP) 23162224.2
Mar. 24, 2023 (EP) 23163993.1

(51) Int. Cl. H01Q 21/28; H01Q 1/22; H01Q 1/44; H04B 1/036; H04B 1/38

(52) U.S. Cl. CPC H01Q 21/28; H01Q 1/22; H01Q 1/44; H04B 1/036; H04B 1/38

(57) ABSTRACT

The invention provides a streetlight luminaire arrangement comprising a housing arrangement, a light generating device, an antenna system, and a radio system; wherein: the light generating device comprises a solid state light source, wherein the light generating device is configured to generate device light; wherein the housing arrangement comprises a first enclosure, wherein the light generating device is at least partly enclosed by the first enclosure; wherein the radio system comprises a radio unit, wherein the radio unit is communicatively coupled to the antenna system; wherein the antenna system and the radio system are at least partly enclosed by the housing arrangement; and wherein the antenna system is configured to transmit and/or receive wireless signals; wherein the antenna system comprises two antenna modules for transmitting and/or receiving the wireless signals, wherein the antenna modules each comprise an antenna boresight axis (AM), wherein the antenna boresight axes (AM) of the two antenna modules have a first mutual angle (α) selected from the range of 55-88°.

### FIELD OF THE INVENTION

The invention relates to a luminaire arrangement, and in particular to a luminaire arrangement for a streetlight. Further, the invention relates to a streetlight, comprising such luminaire arrangement, and to an area lighting system. Further, the invention relates to a method of conveying an RF signal using such a lighting system.

### BACKGROUND OF THE INVENTION

Luminaires for streetlights are known in the art. For instance, WO2022172212A1 describes a device for implementing telecommunications functions, particularly fixed and mobile ones, the device being configured for implementing telecommunications functions in a lighting apparatus, the device comprising: a connection section configured to associate the device to a lighting apparatus, the connection section comprising at least one interface element structured to enable to electrically supply the device, the device being configured to operate in an integration condition wherein the device is located partially or completely inside a containment body of a lighting apparatus and the connection section is coupled to a power supply device of the lighting apparatus; a telecommunications section comprising: an access stage configured to receive/send data packets from/to at least one mobile device (MD), a backhauling stage configured to send/receive data packets to/from the back-hauling stage of a further device integrated in another lighting apparatus; at least one antenna for the access stage; at least one antenna for the backhauling stage, each antenna enabling the respective stage to send and/or receive data packets, the access stage being configured to send to a mobile and/or fixed device and/or to receive from a fixed and/or mobile device data packets according to a first protocol, the backhauling stage being configured to send data packets to a backhauling stage of a further device integrated in another lighting apparatus and/or to receive data packets from a backhauling stage of a further device integrated in another lighting apparatus according to a second protocol, the first protocol and the second protocol being different from each other.
WO2014141312A1 discloses a street type lighting body integrated with telecommunication devices.
U.S. Pat. No. 9,726,360B1 discloses luminaires having wireless antenna.
US20220086989A1 discloses an aerially mounted wireless networking device antenna system.
CN208687548U discloses a kind of street lamp type antenna.
US20170289897A1 discloses a system operative to facilitate an embedded millimeter-wave communication component.

### SUMMARY OF THE INVENTION

Luminaires for streetlights have been continuously developed for a number of decades. It seems useful to integrate an antenna system and a radio frequency transceiver with a luminaire for a streetlight, e.g., for the purposes of providing wireless connectivity to individuals in the vicinity of the streetlight and/or to form a connectivity grid. Performance of such wireless connectivity in streetlights is often still quite low due to blockage of second and receiving signals by e.g. trees. Additionally, introducing such functions into streetlights brings substantial costs for hardware, software, installation, and maintenance. Therefore, it is desired to improve the performance, in terms of communication capabilities, such as via wireless connectivity, as well as to lower the cost of installation and maintenance of luminaires for streetlights.

Hence, it is an aspect of the invention to provide an alternative luminaire, which preferably further at least partly obviates one or more of above-described drawbacks. The present invention may have as object to overcome or ameliorate at least one of the disadvantages of the prior art, or to provide a useful alternative.

According to a first aspect, the invention provides a streetlight luminaire arrangement (“arrangement”) comprising a housing arrangement, a light generating device, an antenna system, and a radio system. In embodiments, the light generating device may comprise a solid state light source. The light generating device may especially, in embodiments, be configured to generate device light. Especially, the light generating device may be configured to generate device light for illuminating an (outdoor) area. Therefore, in specific embodiments, the light generating device may be configured to generate (at least) visible device light. Further, in embodiments, the housing arrangement may comprise a first enclosure. The light generating device may especially, in embodiments, be at least partially enclosed by the housing arrangement. Yet further, in embodiments, the radio system may comprise a radio unit. In such embodiments, the radio unit may especially be communicatively coupled to the antenna system. The radio system and the antenna system may, in embodiments, be at least partly enclosed by the housing arrangement. Further, the antenna system may be configured to transmit and/or receive wireless signals, especially to transmit wireless signals, or especially to receive wireless signals. Therefore, in embodiments, the antenna system may comprise two antenna modules. In some embodiments, the antenna system may (even) comprise at least two antenna modules. Especially, the two antenna modules may both be configured for transmitting and/or receiving the wireless signals. The antenna modules may each comprise an antenna boresight axis (A_{M}). The antenna boresight axes (A_{M}) of the two antenna modules may have a first mutual angle (α). In embodiments, the first mutual angle (α) may especially be selected from the ranges of 55-88° or 92-160°. Hence, in specific embodiments, the invention provides a streetlight luminaire arrangement comprising a housing arrangement, a light generating device, an antenna system, and a radio system; wherein: the light generating device may comprise a solid state light source, wherein the light generating device may be configured to generate device light; wherein the housing arrangement may comprise a first enclosure, wherein the light generating device may be at least partially enclosed by the first enclosure; wherein the radio system may comprise a radio unit, wherein the radio unit may be communicatively coupled to the antenna system; wherein the antenna system and the radio system may be at least partly enclosed by the housing arrangement; and wherein the antenna system may be configured to transmit and/or receive wireless signals; wherein the antenna system may comprise two antenna modules for transmitting and/or receiving the wireless signals, wherein the antenna modules may each comprise an antenna boresight axis (A_{M}), wherein the antenna boresight axes (A_{M}) of the two antenna modules may have a first mutual angle (α) selected from the ranges of 55-88° or 92-160°.

With such an arrangement it may be possible to incorporate components for providing a wireless connectivity grid into a streetlight system in a facile manner. The present invention may further provide improved wireless performance of streetlight luminaires through optimization of the angle between the antenna modules. Especially, in embodiments, the angles described in the present invention may provide a wireless coverage in a V-shaped direction. Hence, in embodiments, such angles between the antenna modules may provide improved performance of the two antenna modules relative to each other with sufficient overlap while providing relatively wide horizontal coverage. Hence, in embodiments, the present invention may provide a streetlight comprising two antenna modules arranged in a V-shaped configuration. Further, an arrangement as described herein by using two antenna modules arranged as such may provide a more cost-efficient and power-efficient luminaire arrangement for streetlights with wireless connectivity.

As indicated above, in embodiments the streetlight luminaire arrangement may comprise a housing arrangement, a light generating device, an antenna system, and a radio system.

In embodiments, the streetlight luminaire arrangement may comprise the light generating device. Especially, in embodiments, the light generating device may be configured to generate device light. More especially, the light generating device may be configured to generate device light along an optical axis (O), see also further below. In embodiments, the light generating device may especially be configured to generate device light for illuminating an area, such as an outdoor area.

The light generating device may, in embodiments, comprise a light source. Especially, in embodiments, the light generating device may comprise a solid state light source, such as a light emitting diode (LED). Note that the term “a light source” may also refer to a plurality of light sources, see also further below. The light source may be configured to generate light source light. Especially, the device light may comprise (at least part of) the light source light. More especially, in embodiments, the light source light may essentially be fully comprised by the device light. In embodiments, the light generating device may especially be configured to generate visible device light, i.e., light with spectral power in the visible wavelength range (380-780 nm). Especially, the device light may be white light. More especially, in embodiments, the white light may have a correlated color temperature selected from the range of 1800-6500 K and/or a color rendering index of at least 70, such as at least 80. However, in other embodiments, the device light may also be colored light. In yet other embodiments, the device light may have a wavelength in one of the UV and IR wavelength range. Hence, the streetlight luminaire arrangement may be configured to provide device light, especially at least visible (device) light. In embodiments, the spectral power distribution of the device light may be controllable.

As mentioned above, in embodiments, the streetlight luminaire arrangement may be used outdoors. Therefore, it may be desired to protect the electrical elements, such as the light generating device, the antenna system, and the radio system against ingress of dust, water, and moisture. Hence, in embodiments, the streetlight luminaire arrangement may comprise a housing arrangement. In embodiments, the housing arrangement may comprise a first enclosure. The light generating device may, in embodiments, be at least partially configured in the first enclosure. Especially, in some embodiments, the light generating device may be essentially fully configured in the first enclosure.

Further, in embodiments, the antenna system and the radio system may (also) be at least partially enclosed by the housing arrangement. Especially, in some embodiments, the antenna system may be at least partially configured in the first enclosure. Hence, in such embodiments, the antenna system may be at least partially enclosed by the first enclosure. Further, in embodiments, the antenna system may (even) be fully enclosed by the first enclosure. Likewise, in some embodiments, the radio system may be at least partially configured in the first enclosure. Hence, in such embodiments, the radio system may be at least partially enclosed by the first enclosure. Further, in embodiments, the radio system may (even) be fully enclosed by the first enclosure. In embodiments, both the radio system and the antenna system may be at least partially (such as (even) fully) enclosed by the first enclosure.

In embodiments, the first enclosure may have a shape. Especially, in embodiments, the first enclosure may have one of a (hollow) cuboid shape, a (hollow) prismatic shape, a (hollow) cone shape, a (hollow) ovoid shape, or a (hollow) spheroid shape. More especially, in specific embodiments, the first enclosure may have a ‘cobra-head’ shape. However, other shapes may be possible as well. Therefore, in embodiments, the first enclosure may especially comprise one or more walls. The one or more walls may, in embodiments, comprise one or more materials selected from the group comprising a (bio) plastic, a glass, and a metal. Further, in embodiments, the first enclosure may comprise a (transmissive) light exit window, see also further below. Especially, the one or more walls and the light exit window may form the first enclosure. In embodiments, the light generating device may (at least partially) be configured between the one or more walls and the light exit window. Hence, as such, the first enclosure, especially the one or more walls and the light exit window may provide protection of the light generating devices against ingress of dust, water, and moisture.

Further, in embodiments, the first enclosure may (also) comprise additional optics, such as for example a light mixing chamber or one or more reflectors. Such optics may provide features such as beam shaping.

Yet further, in embodiments, the streetlight luminaire arrangement may comprise an antenna system. Especially, in embodiments, the antenna system may comprise two antenna modules, see also further below. In some embodiments, the antenna system may comprise more than two antenna modules, for example, the antenna system may comprise two sets of one or more antenna modules. Further, in embodiments, the antenna system (and thus the two antenna modules) may especially be at least partially configured in (such as enclosed by) the housing arrangement. In some embodiments, the antenna system may especially be essentially fully configured in the housing arrangement. However, in other embodiments, at least part of the antenna system may be configured outside of the housing arrangement. For example, in embodiments where the walls of the first enclosure may be metal walls, the walls may be less transmissive for wireless signals. Therefore, in such embodiments, the two antenna modules may be (at least partially) configured outside of the housing arrangement. For example, in such embodiments, the walls of the (housing arrangement, especially the) first enclosure may comprise one or more holes. Especially, in embodiments, the antenna modules may be configured protruding through the one or more holes, such that wireless signals may not need to pass through the first enclosure walls.

As described here, the first enclosure may be provided such that it may be possible for wireless signals to reach the antenna modules. Especially, in embodiments, the antenna system may be configured to transmit and/or receive wireless signals. More especially, in embodiments, the antenna system may be configured to transmit wireless signals. Further, in embodiments, the antenna system may be configured to receive wireless signals. In specific embodiments, the antenna system may be configured to both transmit and receive wireless signals. Therefore, the antenna system may comprise the antenna modules. In embodiments, an antenna module may comprise an electronic chip. For example, the antenna module may comprise the electronic chip configured onto a printed circuit board (PCB). In embodiments, the antenna system may especially comprise two antenna modules both configured for transmitting and/or receiving the wireless signals. Hence, in such embodiments, both of the two antenna modules may be configured for both transmitting and receiving wireless signals. In other embodiments, one of the two antenna modules may be configured for transmitting wireless signals, and the other may be configured for receiving wireless signals. Especially, in such embodiments, the two antenna modules may be configured communicatively coupled (for example through the radio system).

Further, in embodiments, the (two) antenna modules may each comprise an antenna boresight axis (A_{M}). A boresight axis may herein refer to an imaginary line along which maximum gain (or “maximum radiated power”) of the antenna module is achieved. Hence, in embodiments, the (two) antenna modules may be configured to transmit and/or receive wireless signals along their respective boresight axis (A_{M}). The antenna boresight axes (A_{M}) of the two antenna modules may especially, in embodiments, be configured in a plane (P). In other words, in embodiments, the antenna boresight axes (A_{M}) of the two antenna modules may extend in the plane (P). Further, in embodiments, the antenna boresight axes (A_{M}) of the two antenna modules may have a first mutual angle (α). Especially, in embodiments, the first mutual angle (α) may be selected from the range of 30-180°. More especially, in embodiments, the first mutual angle (α) may be selected from the range of 45-90°, such as from the range of 55-88°, like from the range of 60-80°. In such embodiments especially, lower gain regions of the two antenna modules may overlap, such that their combined performance may improve these regions. Hence, the antenna modules herein may especially be directional antenna modules.

As mentioned above, the two antenna modules may be configured communicatively coupled, for example through the radio system. Hence, in embodiments, the streetlight luminaire arrangement may comprise a radio system. Especially, in embodiments, the radio system may comprise a radio unit, see also further below.

Further, in embodiments, the radio system, similarly to the antenna system, may be at least partially configured in (such as enclosed by) the housing arrangement. Especially, in some embodiments, the radio system (and thus the radio unit) may especially be essentially fully configured in the housing arrangement. However, in other embodiments, at least part of the radio system may be configured outside of the housing arrangement.

Yet further, in embodiments, the streetlight luminaire arrangement may comprise further additional elements. For example, in embodiments, the streetlight luminaire arrangement may comprise one or more the group comprising a driver, a power splitter, a heat sink, and a sensor.

In embodiments, a driver may especially be functionally coupled to one or more of the light generating device and the radio system. The driver may, in embodiments, be functionally coupled to a power source, such as a power grid, such that the driver may receive (alternating current) electrical power. Subsequently, in embodiments, the driver may supply (direct current) electrical power to the light generating device and/or the radio system. Especially, the first driver may be configured to control one or more of the light generating device and the radio system. In embodiments, the driver may (also) essentially be comprised by one of the light generating device and the radio system. However, in other embodiments, the driver may be separate from (but coupled to) the light generating device and/or the radio system.

Further, in embodiments, the streetlight luminaire arrangement may comprise a power splitter. The power splitter may be configured to split power provided to the streetlight luminaire arrangement into separate parts. Especially, in embodiments, the power splitter may be configured to direct part of the power provided to the streetlight luminaire arrangement to the light generating device, and to direct another part of the power provided to the luminaire arrangement to the radio system.

The radio system and/or the light generating device may generate heat (during operation). Also the antenna system may generate heat. Accumulating heat may have a negative impact on the performance of these components, and hence thermal management is required. The accumulation of heat may be prevented by providing means for the (passive) diffusion of heat. Hence, in embodiments, the streetlight luminaire arrangement may further comprise a heatsink. A heatsink may have specific features that aid the thermal management of the streetlight luminaire arrangement. For example, a heatsink may comprise a thermally conductive material, such as a metal. In embodiments, for example, the (walls of the) first enclosure may comprise a thermally conductive material. Furthermore, a heatsink may comprise a plurality fins. Heatsinks are known in the art. The term “heatsink” (or heat sink) may especially be a passive heat exchanger that transfers the heat generated by device, such as an electronic device or a mechanical device, to a fluid (cooling) medium, often air or a liquid coolant. Thereby, the heat is (at least partially) dissipated away from the device. A heat sink is especially designed to maximize its surface area in contact with the fluid cooling medium surrounding it. Hence, especially a heatsink may comprise a plurality of fins. For instance, the heatsink may be a body with a plurality of fins extending thereof. A heatsink especially comprises (more especially consists of) a thermally conductive material. The term “heatsink” may also refer to a plurality of (different) heatsinks.

Especially, in embodiments, the heatsink may be configured in thermal contact with at least one of: at least part of the antenna system and at least part of the radio system, such as in thermal contact with at least part of both the antenna system and the radio unit. More especially, in embodiments, the heatsink may be configured in thermal contact with one or more of the one or more antenna modules, the radio unit, the power splitter, and the driver.

Instead of or in addition to heatsinks, also other thermally conductive elements may be applied, like heat spreaders or two-phase cooling devices (such as a heat pipe or a vapor chamber).

Further, in embodiments, the streetlight luminaire arrangement may also comprise additional antenna modules. For example, in embodiments, the streetlight luminaire arrangement may comprise two sets of the two antenna modules as described herein (i.e. having respective boresight axes (A_{M}) with a first mutual angle (α)). In such embodiments, especially, the two sets of two antenna modules may be configured such that their respective antenna boresight axes (A_{M}) may be configured facing in opposite directions, i.e., antiparallel. In other embodiments, the streetlight luminaire arrangement may comprise four antenna modules. Especially, in such embodiments, the four antenna modules may be configured at (about) 90° angles relative to each other. In yet other embodiments, the streetlight luminaire arrangement may comprise a set of two antenna modules and a separate third antenna module. Especially, in such embodiments, the third antenna module may be configured with its respective antenna boresight axis (A_{M}) facing antiparallel to an average of the two boresight axes (A_{M}) of the set of two antenna modules (i.e. a center axis (A₁₂), see further below). In other such embodiments, the third antenna module may be configured such, that the antenna boresight axis (A_{M}) of one of the original antenna modules and an antenna boresight axis (A_{M}) of the third antenna module may be configured in a V-shape. In yet other embodiments, the streetlight luminaire arrangement only comprises the two antenna modules having the first mutual angle (α) as described herein.

As mentioned above, in embodiments, the first enclosure may comprise a light exit window. The light exit window may especially be transmissive for at least part of the device light, such as all of the device light. Hence, in embodiments, the first enclosure may comprise a light exit window being transmissive for at least part of the device light.

The light exit window may comprise a window panel that may be at least partially translucent, especially at least partially transparent. The light exit window may, for example, comprise a material selected from the group comprising polymeric material and glass. Furthermore, in embodiments, the light exit window may comprise a plurality of smaller light exit windows (or “plates”). For example, in embodiments, the light exit window may comprise a four sided inverse cone or pyramid shaped exit window, i.e., the light exit window may comprise multiple plates configured together in a 3D shape. In (other) embodiments, the light exit window may have a (2D) cross-sectional shape selected from the group comprising a round shape, an elliptical shape, a hexagonal shape, and a rectangular shape. Further, in embodiments, the light exit window may have a 3D shape, such as one of a cobra-head shape, a (rounded) cone shape, and a rustum(-like) shape.

As mentioned above, in embodiments, the antenna boresight axes (A_{M}) of the two antenna modules may have a first mutual angle (α). Especially, in specific embodiments, the first mutual angle (α) may be selected from the range of 55-75°. Such embodiments may especially be beneficial as configuring the antennas at such an angle may provide wireless connection with optimized overlap for (near) maximum performance.

An antenna module may have a decaying gain when moving away from the boresight axis (A_{M}). Therefore, an antenna module may be used to provide transmission and reception of wireless signals mainly in a singular direction. Especially, in embodiments, an antenna module may efficiently provide transmission and reception of wireless signals over a maximum angle of about 90°, with the highest gain achieved at about 45°. Therefore, it may be desirable to use two antenna modules, such that a wider maximum angle may be achieved. Due to the decay in gain when moving away from the antenna boresight axis (A_{M}), placing the antenna modules such that their axes are perpendicular may leave a gap in the efficiency of the antenna system. By placing the antenna modules such, that their antenna boresight axes (A_{M}) have a first mutual angle (α) selected from the range of 55-88°, especially selected from the range of 55-75°, such as selected from the range of 60-70°, the efficiency of the antenna system may be improved, while creating relatively little (excess) overlap between the two antenna modules.

Further, in specific embodiments, the first mutual angle (α) may be selected from the range of 75-88°. Such embodiments may especially be beneficial as configuring the antennas at such an angle may provide wireless connection with improved maximum coverage while still providing sufficient overlap (for sufficient performance).

Hence, by placing the antenna modules such, that their antenna boresight axes (A_{M}) have a first mutual angle (α) selected from the range of 55-88°, especially selected from the range of 75-88°, such as selected from the range of 78-85°, the maximum coverage of the antenna system may be improved. Especially, in such embodiments, the antenna modules may be configured with their antenna boresight axes (A_{M}) at an angle (α) as wide as possible, while still providing sufficient overlap between the two antenna modules.

As mentioned above, in embodiments, the streetlight luminaire arrangement may comprise a first enclosure. Additionally, in embodiments, the streetlight luminaire arrangement may comprise a second enclosure. In embodiments, the second enclosure may be functionally coupled to the first enclosure. Especially, the second enclosure may be physically attached, such as glued or bolted, to the first enclosure. The second enclosure and first enclosure may be functionally coupled (such as electrically coupled and/or physically coupled) in a direct manner or in an indirect manner (e.g., through other (electrical) components configured in between the first enclosure and second enclosure). Further, in embodiments, the second enclosure may at least partially enclose the antenna system. Yet further, in embodiments, the second enclosure may at least partially enclose the radio system. Yet further, in embodiments, the second enclosure may at least partially enclose the antenna system and the radio system. In embodiments, the second enclosure may especially be arranged on top of the first enclosure. Especially, in embodiments, the second enclosure may at least partially cover the first enclosure. In some embodiments, the second enclosure may essentially fully cover the first enclosure. Hence, in specific embodiments, the streetlight luminaire arrangement may comprise a second enclosure, functionally coupled to the first enclosure, wherein the second enclosure may at least partially enclose the antenna system and the radio system, and wherein the second enclosure may be arranged on top of the first enclosure.

Such embodiments may be beneficial as a second enclosure, comprising the antenna system and the radio unit may be attached to existing streetlight luminaires in a relatively easy manner to provide wireless connectivity to existing streetlight systems. Further, in such embodiments, the second enclosure may also improve ease of (re) placing the second enclosure (comprising the antenna system and the radio unit), for example in case of maintenance. Yet further, the second enclosure may provide protection of the antenna system and the radio system against ingress of dust, water, and moisture.

Hence, in embodiments, the second enclosure may at least partially enclose the antenna system and the radio system. Especially, in such embodiments, the antenna system and the radio system may be essentially fully enclosed by the second enclosure.

In embodiments, the second enclosure may have a shape such as described for the first enclosure above. Especially, in embodiments, the second enclosure may comprise one or more (second) walls. The one or more (second) walls, may, in embodiments, especially form the second enclosure. As such, the one or more walls may provide protection against ingress of dust, water, and moisture for components configured inside the second enclosure, such as e.g. the radio system and/or the antenna system.

In embodiments, the one or more (second) walls may comprise one or more materials selected from the group comprising a (bio) plastic, a glass, and a metal. However, in embodiments, other materials may also be possible. In some embodiments, the wall material may provide a barrier, i.e., the material may reduce the efficiency of transmission and reception of wireless signals between the antenna modules and an external device or apparatus. Hence, in such embodiments, the one or more (second) walls may comprise a material less transmissive for wireless signals, for example the one or more (second) walls may comprise a metal. Especially, in such embodiments, the second enclosure, especially the one or more (second) walls may comprise one or more antenna module openings, such that wireless signals may pass through the one or more antenna module openings. Such embodiments may provide the benefit of improved wireless connectivity as the negative effect of the barrier is reduced substantially or even removed completely. Hence, allowing the antenna module to protrude the second enclosure provides improved wireless connectivity. Similarly, in embodiments, such one or more antenna module openings may also be provided in the one or more walls of the first enclosure.

In some embodiments, the first enclosure and the second enclosure may have essentially the same shape. Hence, in such embodiments, the second enclosure may be configured on the first enclosure, such that it may essentially fully cover the first enclosure. However, in other embodiments, the first enclosure and the second enclosure may have a different shape. In such embodiments, for example, the second enclosure may be smaller than the first enclosure. Hence, in such embodiments, the second enclosure may (only) partially cover the first enclosure. However, this may not necessarily be the case.

Further, in embodiments, the streetlight luminaire arrangement may also comprise a printed circuit board for support of one or more (solid state) light sources. The printed circuit board may, in embodiments, comprise a first face. Especially, in such embodiments, the solid state light source may be functionally coupled, such as physically and/or electrically coupled, to the first face of the printed circuit board. Furthermore, in embodiments, the antenna boresight axes (A_{M}) may have a first angle (γ₁) with the first face of the printed circuit board. Especially, in embodiments, the first angle (γ₁) may be selected from the range of 0-25° such as selected from the range of 0-15°, like selected from the range of 0-5°. In specific embodiments, the antenna boresight axes (A_{M}) (configured in the plane (P)) may be configured essentially parallel to the first face of the PCB, i.e., γ₁=0° Hence, in specific embodiments, the streetlight luminaire arrangement may comprise a printed circuit board, wherein the printed circuit board may comprise a first face, wherein the solid state light source may be functionally coupled to first face of the printed circuit board; wherein the antenna boresight axes may have a first angle (γ₁) with the first face selected from the range of 0-25°.

Such embodiments may especially be beneficial when operating the streetlight luminaire arrangement in a conventional streetlight system. Especially, the above described embodiments may provide the benefit of receiving and/or transmitting wireless signals from the antenna modules such that when two or more streetlight luminaire arrangements are configured at approximately the same height and facing each other in an area, such as a street, wireless communication between them may be achieved with improved efficiency. Further, the above described embodiments may be beneficial as providing the antenna modules such that the antenna boresight axes may have a nonzero first angle (γ₁) with the first face of the PCB may provide flexibility in the placement of the streetlight luminaire arrangement. For example, in embodiments, the streetlight luminaire arrangement may be placed on poles of equal height spread over an area with significant height differences, e.g., going up a hill. In such embodiments, the placement of the antenna modules such that the antenna boresight axes may have a nonzero first angle (γ₁) with the first face of the PCB may provide connectivity in a relatively simple manner, without requiring additional measures or materials.

In embodiments, the printed circuit board (PCB) may be configured to support the light generating device. Hence, the printed circuit board may especially, in embodiments, be configured in the first enclosure. Especially, in embodiments, the solid state light source may be configured on the PCB. Hence, in such embodiments, the solid state light source may be physically coupled to the PCB. Further, in embodiments, the solid state light source may also be electrically connected to the PCB, i.e., the PCB may be configured to provide electricity to the solid state light source.

The first face may especially, in embodiments, be configured facing away from the two antenna modules. More especially, in specific embodiments, the first face may be configured facing towards the area to be illuminated by the streetlight luminaire arrangement, such as facing a street. Hence, in such embodiments, the first face of the PCB may be configured in a plane perpendicular to the direction of gravity.

Further, in embodiments, the two antenna modules may have a center axis (A₁₂). The center axis (A₁₂) may especially be defined in the plane (P), such that the center axis (A₁₂) may provide an averaged axis of the two boresight axes (A_{M}) together. Hence, especially the two boresight axes (A_{M}) are (essentially) in the same plane.

In embodiments, the streetlight luminaire arrangement may especially be configured to generate a beam of device light. The beam of device light may, in embodiments, have an optical axis (O). The optical axis (O) may be defined as an axis along which the device light propagates out of the streetlight luminaire arrangement during operation of the light generating device. Hence, the optical axis (O) may be defined as an imaginary line that defines the average direction of the beam of device light. As mentioned above, the antenna boresight axes (A_{M}) may be configured in a plane (P). The plane (P) may, in embodiments, have a normal (N), i.e., an imaginary line perpendicular to the plane (P). In embodiments, the optical axis (O) may have a second angle (γ₂) with the normal to the plane (P). The second angle (γ₂) may especially be selected from the range of 0-25° such as selected from the range of 0-15°, like selected from the range of 0-5°. In specific embodiments, the optical axis (O) may essentially coincide with the normal (N) of the plane (P), i.e., γ₂=0°. Hence, in specific embodiments, the streetlight luminaire arrangement may be configured to generate a beam of device light, wherein the beam of device light may have an optical axis (O), defined as an axis along which the device light propagates during operation of the light generating device, wherein the antenna boresight axes (A_{M}) may be configured in a plane (P), wherein the optical axis (O) may have a second angle (γ₂) with a normal (N) to the plane (P) selected from the range of 0-25°.

Such embodiments may especially be beneficial when operating the streetlight luminaire arrangement in a conventional streetlight system. Especially, the above described embodiments may provide the benefit of providing device light to an area slightly offset from the position of the streetlight luminaire arrangement. For example, the streetlight luminaire arrangement may be configured on a pole positioned at the side of a highway, i.e., at the verge. In such embodiments, the normal (N) of the plane (P) may be configured in the direction of gravity. Especially, in such embodiments, by configuring the light generating device such that the optical axis (O) is slightly offset from the normal (N) of the plane (P), device light may be provided (farther) onto the highway, rather than part of the highway and part of the verge. In another example, in embodiments, the above described may be beneficial as providing the antenna modules such that the normal (N) of the plane (P) may have a nonzero second angle (γ₂) with the optical axis (O) may provide flexibility in the placement of the streetlight luminaire arrangement. For example, in embodiments, the streetlight luminaire arrangement may be placed on poles of equal height spread over an area with significant height differences, e.g., going up a hill. In such embodiments, the placement of the antenna modules, i.e., the plane (P), such that the normal (N) to the plane (P) may have a nonzero second angle (γ₂) with the optical axis (O) may provide connectivity in a relatively simple manner, without requiring additional measures or materials.

The first angle (γ₁) and the second angle (γ₂) may, in embodiments, be correlated. Especially, in embodiments, as the first angle (γ₁) is increased e.g. from 0° to 5° (e.g. the antenna modules (and thus their boresight axes (A_{M})) are configured facing 5° down or up relative to the first face of the PCB), as a result, the second angle (γ₂) may also increase from 0° to 5°. Hence, in such embodiments, the normal (N) to the plane (P) may have a second angle (γ₂) of 5° relative to the optical axis (O). In other embodiments, as the second angle (γ₂) is increased e.g. from 0° to 5° (e.g. the optical axis (O) is configured extending 5° forward or backward) as a result, the first angle (γ₁) may also increase from 0° to 5°, however, this is not necessarily true. For example, in such embodiments, the optical axis (O) may have a second angle (γ₂) of 5° with the normal (N) of the plane (P), whereas the antenna boresight axes (A_{M}) may still have a first angle (γ₁) of zero degrees relative to the first face of the PCB.

In embodiments, the streetlight luminaire arrangement may be configured to generate a beam of device light. The beam of device light may, in embodiments, may have a cross-sectional distribution with a shape approximating one of a circular shape, an oval shape, a “bat-wing” shape, a heart shape, an ovoid shape, a dumbbell shape, a donut shape, and a drop shape. Further, in embodiments, the cross-sectional distribution of the beam of device light may comprise two or more shapes. Especially, in such embodiments, the beam of device light may essentially consist of two or more lobes. In such embodiments, the two or more lobes may each comprise a cross-sectional shape approximating one of a circular shape, an oval shape, a “bat-wing” shape, a heart shape, an ovoid shape, a dumbbell shape, a donut shape, and a drop shape.

The beam of device light may, in embodiments, have an optical axis (O). Especially, herein, the optical axis may be defined as an axis (i.e., and imaginary line) along which the device light propagates from the streetlight luminaire arrangement during operation of the light generating device. In embodiments, the optical axis may thus define an average direction of the total beam of device light. For example, in embodiments where the beam of device light has a circular cross-sectional distribution, the optical axis (O) may (essentially perpendicularly) extend through a center point of the circular cross-sectional distribution. In another example, in embodiments where the beam of device light may have an ovoid cross-sectional distribution. In such embodiments, the cross-sectional distribution of the beam of device light may have a larger side and a smaller side. Hence, in such embodiments, the optical axis (O) may extend through a point off-center and towards the larger side of the cross-sectional distribution. In yet other embodiments, the beam of device light may have a “bat-wing” shaped cross-sectional distribution. In such embodiments, the cross-sectional distribution of the beam of device light may have two connected lobes, such that the optical axis (O) may extend through the intersection of the two lobes, especially, the optical axis (O) may extend through the center of mass of the shape of the cross-sectional distribution. Similarly, in embodiments where the beam of device light may have a donut shape, the optical axis (O) may also extend through the center of mass of the donut shape. Hence, in such embodiments, the optical axis (O) may actually fall outside of the beam of light, i.e., the beam of light forms a donut shape around (but slightly avoiding) the optical axis (O).

As described above, the streetlight luminaire arrangement may comprise an antenna system comprising two antenna modules. In embodiments, each antenna module may especially comprise a plurality of antennas. Especially, in embodiments, the plurality of antennas in each antenna module may comprise a plurality of radio frequency (RF) antennas. More especially, the plurality of (RF) antennas in each antenna module may, in embodiments, be configured in a planar (or two dimensional) arrangement. Hence, in specific embodiments, each antenna module may comprise a plurality of antennas configured in a planar arrangement.

In embodiments, each antenna module may have a length (L_{AM}), a width (W_{AM}), and a height (H_{AM}). In embodiments, the antenna module length (L_{AM}) may be defined in a plane parallel to the plane (P). Especially, the antenna module length (L_{AM}) may be selected from the range of 25-250 mm, such as from the range of 50-150 mm, like from the range of 60-100 mm. Further, in embodiments, the antenna module width (W_{AM}) may be defined in a plane parallel to the plane (P). Especially, the antenna module width (W_{AM}) may be selected from the range of 10-150 mm, such as from the range of 20-80 mm, like from the range of 25-50 mm. Yet further, in embodiments, the antenna module height (H_{AM}) may be defined in a plane perpendicular to the plane (P). Especially, the antenna module height (H_{AM}) may be selected from the range of 20-200 mm, such as from the range of 30-100 mm, like from the range of 35-60 mm.

Further, in embodiments, an antenna module may comprise an antenna module housing. Especially, in embodiments, the antenna module housing may comprise a backplate, and a cover. Especially, in embodiments, the plurality of (RF) antennas (or “antenna patches”) may be configured on the backplate. More especially, in specific embodiments, the plurality of antennas may be configured on an antenna printed circuit board (PCB). In such embodiments, especially, the antenna PCB may be configured on the backplate. Therefore, in embodiments, the backplate may comprise a material selected from the group comprising a (bio) plastic, a metal, a ceramic, and wood.

The antenna backplate (especially the antenna PCB) may, in embodiments, be configured to support the plurality of antennas. Especially, in embodiments, the antenna backplate may comprise one or more 2D arrays of antennas. Hence, in embodiments, the antenna backplate PCB may comprise one or more n*m arrays of antennas. Herein, in embodiments, n and m may be individually selected from the range of 3-30, such as from the range of 5-25, like from the range of 8-15. For example, in embodiments, the antenna backplate may comprise a 6×10 2D array of antennas. Further, in embodiments, the antenna backplate may (also) comprise multiple sets of 2D arrays. For example, in embodiments, the antenna backplate may comprise two sets of 6×10 2D arrays. In such embodiments, the different sets may enable implementation of phased array technology, i.e., the different sets of 2D arrays may be assembled, such that radiation patterns of the individual antennas may be combined with neighboring antennas to form an overall effective radiation pattern. With such a system, especially, steering of radiation beams (or “radiation lobes”) from the antenna modules may be controlled. However, in embodiments, other beam steering antenna technologies, such as holographic antennas, may be possible as well. Further, in embodiments, the plurality of (RF) antennas may also be configured in a 2D array different from an n*m array, such as for example a 2D spiral array, or a 2D sunflower array Yet further, in embodiments, the plurality of (RF) antennas may (even) be configured in a multilayer (3D) array. In yet other embodiments, the plurality of (RF) antennas may be configured in a directional microstrip antenna array.

In embodiments, the plurality of antennas may each have a largest dimension (such as a length, a width, or a diameter) selected from the range of 1-20 mm, such as from the range of 1-10 mm, like from the range of 2-5 mm. The term “antenna” may in embodiments especially refer to antennas “antenna patch”.

As mentioned above, the antenna module may also comprise a cover. In embodiments, the cover may especially be functionally (especially physically,) coupled to the backplate, such that the backplate and the cover may essentially enclose the plurality of antennas (configured on the antenna PCB). In embodiments, the cover may be chosen such, that the antenna module may be transmissive for wireless signals, i.e., wireless signals may pass through the cover to be received and/or transmitted by the plurality of antennas. Therefore, in embodiments, the cover may especially comprise a polymeric material, such as a plastic. However, in embodiments, other materials may also be possible. In some embodiments, the cover material may provide a barrier, i.e., the material may reduce the efficiency of transmission and reception of wireless signals between the antennas and an external device or apparatus. Hence, in such embodiments, the cover may comprise a material less transmissive for wireless signals, for example the cover may comprise a metal. Especially, in such embodiments, the cover may comprise one or more antenna openings, such that wireless signals may pass through the one or more antenna openings. For example, in embodiments, the cover may comprise n*m antenna openings aligned with their respective n*m antennas. Such embodiments may provide the benefit of improved wireless connectivity as the negative effect of the barrier is reduced substantially or even removed completely. Hence, allowing the antennas to protrude the cover provides improved wireless connectivity.

Further, as mentioned above, in embodiments, the radio system may comprise a radio unit. The radio unit may, in embodiments, be configured to (a) control the transmission of wireless signals transmitted by the antenna system and/or (b) process wireless signals received by the antenna system, such as control the transmission of wireless signals transmitted by the antenna system, and such as process wireless signals received by the antenna system.

The term “radio unit” may be equally substituted by terms such as “wireless module” or “radio frequency transceiver”. In embodiments, the radio unit may be functionally coupled to the antenna system. Especially, the radio unit may be at least one of electrically and communicatively coupled to the antenna system, such as both. In other words, the radio unit and the antenna system may have functions interacting with one another. Especially, in embodiments, the radio unit may have at least one of a controlling or processing function, such as both a controlling and processing function. Herein a controlling function may refer to controlling a transmission of wireless signals, such as electromagnetic signals like radio signals. A processing function may refer to processing of received wireless signals. More especially, the radio unit may be configured to (a) control the transmission of wireless signals transmitted by the antenna system, and to (b) process wireless signals received by the antenna system. In embodiments, the radio unit may, for instance, comprise a modem, a processing unit and/or an input/output unit. Suitable examples of radio units for handling and processing wireless signals are well established in the art, and have not been described in detail for the sake of clarity.

The wireless signals controlled by the radio unit may operate according to any known wireless communication protocol. Suitable wireless communication protocols include a wireless local area network protocol such as in accordance with the IEEE 802.11 standards, a 2G, 3G, 4G, 5G or 6G telecommunication protocol, and so on. Other formats will be readily apparent to the person skilled in the art. In specific embodiments, the radio unit may be configured to operate according to a 4G or higher telecommunication protocols. Likewise, the antenna module may be configured to transmit and/or receive wireless signals, such as a wireless local area network protocol such as in accordance with the IEEE 802.11 standards, a 2G, 3G, 4G, 5G or 6G telecommunication protocol.

In some examples, the wireless signals transmitted and/or received by the radio system and antenna system are unrelated to the operation of the light generating device. In particular examples, the two antenna modules and the radio unit may act as a node for a network of nodes for providing wireless coverage within an area covered by the network of nodes. Thus, the two antenna modules and the radio unit may be configured to act as a node as part of a wireless mesh network. Of course, in other examples, the wireless signals transmitted and/or received by the radio system and antenna system may be related to the operation of the light generating device. Thus, the two antenna modules and the radio unit may act together to provide information for controlling one or more parameters or properties of the light generating device.

Further, in embodiments, the antenna system and the radio system may be configured for 3G communication. Especially, in embodiments, the antenna system and the radio system may be configured for 4G communication. Yet further, in embodiments, the antenna system and the radio system may be configured for communication higher than 4G, such as 5G communication, or such as 6G communication. Especially, in some embodiments, the antenna system and the radio system may be configured for millimeter wave radio frequency technology used for broadband communication. More especially, in embodiments, the antenna system and the radio system may be configured for communication of millimeter wave frequencies, i.e. especially frequencies selected from the range of 24-300 GHz. Hence, especially the antenna system and the radio system may be configured for mmWave (24-300 GHz) RF technology.

In embodiments, the streetlight luminaire arrangement may be part of or may be applied in e.g. garden lighting systems, theater lighting systems, field lighting systems, (outdoor) road lighting systems, urban lighting systems, green house lighting systems, or horticulture lighting, especially street lighting, highway lighting, square lighting, intersection lighting, parking lot lighting, outdoor industrial and logistics area lighting, non-motorized vehicles and sidewalk lighting, and optical communication systems.

Hence, in an aspect the invention may also provide a streetlight. Especially, the invention may provide a streetlight comprising the streetlight luminaire arrangement as described herein and a pole (or “mast”). Especially, in embodiments, the streetlight luminaire arrangement may be functionally coupled to the pole. Especially, the streetlight luminaire arrangement may be mechanically mounted to the pole (or mast). Hence, in specific embodiments, the invention may provide a streetlight comprising the streetlight luminaire arrangement as described herein and a pole, wherein the streetlight luminaire arrangement may be functionally coupled to the pole.

Such a streetlight may provide the benefit of introducing wireless connectivity in a streetlight system. Further, the streetlight as described herein may provide improved efficiency in wireless connectivity as wireless signals may be received and transmitted by the antenna system in a V-shape. Such a V-shape may provide the benefit of avoiding obstacles, such as trees, which inhibit the transfer of signals.

In embodiments, the streetlight luminaire arrangement as described herein may be configured as a streetlight. Especially, in such embodiments, the streetlight luminaire arrangement may be functionally coupled to a pole. More especially, the streetlight luminaire arrangement may be physically (e.g. mechanically) coupled to the pole. Furthermore, in embodiments, the streetlight luminaire may also be electrically coupled to the pole. In such a way, the streetlight luminaire arrangement may be (functionally, especially) electrically coupled to a power source (such as an urban power grid) through the pole.

Typically the streetlight luminaire arrangement is an outdoor streetlight luminaire. A dominant architecture of the streetlight may be a pole with a ‘lantern’ based design, i.e., with a rectangular, triangular, or polygonal cross-sectional shape. Another dominant architecture of the streetlight may be a pole with a ‘cobra-head’ based design. Yet another architecture of the streetlight may be a (3D) disc shaped design, i.e., with a circular or oval cross-sectional shape. Hence, in specific embodiments, the invention may provide a streetlight comprising the streetlight luminaire arrangement as described herein and a pole, wherein the luminaire arrangement may be functionally coupled to the pole and a power source. In embodiments, however, the streetlight luminaire arrangement may also be mounted to a wall. Hence, in such embodiments, the streetlight may comprise a wall-mount streetlight luminaire arrangement and may hence not necessarily need a pole.

However, in embodiments where the streetlight does comprise a pole, for coupling the streetlight luminaire arrangement to the pole, the streetlight may further comprise a coupling element. Hence, in embodiments, the coupling element may be configured to functionally (such as physically and/or electrically) couple the streetlight luminaire arrangement to the pole.

In embodiments, the streetlight luminaire arrangement may have a first side and a second side. Especially, in embodiments, the first side and the second side may define a dimension of the streetlight luminaire arrangement. More especially, in embodiments, the first side and the second side may be opposites. For example, in embodiments, the first side and the second side may define a length of the streetlight luminaire arrangement. In other embodiments, for example, the first side and the second side may define a height of the streetlight luminaire arrangement. Further, in embodiments, one of the following may apply: (a) the coupling element as described above may be configured closer to one of the first side and the second side and the antenna modules may be configured closer to the other one of the first side and the second side, or (b) the coupling element may be configured closer to both the first side and the second side than the antenna modules. Hence, in specific embodiments, the streetlight may comprise a coupling element, wherein the coupling element may be configured to functionally couple the streetlight luminaire arrangement to the pole, wherein the streetlight luminaire arrangement may comprise a first side and a second side, wherein the first side and the second side may define a dimension of the streetlight luminaire arrangement; wherein (a) the coupling element may be configured closer to one of the sides and the antenna modules may be configured closer to the other one of the sides, (b) the coupling element may be configured closer to both sides than the antenna modules.

Such embodiments may be beneficial as by coupling the streetlight luminaire arrangement to the pole on the side opposite the antenna modules, one can place the (pole of the) streetlight on the side of a (n area, such as a) road or street such that the antenna modules can provide wireless connection in a direction along the width of that (area, such as that) road or street.

In embodiments, the streetlight may comprise a pendant or catenary streetlight luminaire arrangement. For example, in embodiments, the streetlight may comprise a streetlight luminaire arrangement suspended from a (steel) cable. Hence, in such embodiments, the pendant/catenary streetlight luminaire arrangement may be coupled to one or more poles via the coupling element, i.e., the cable. In other words, in embodiments of a catenary streetlight luminaire arrangement, the cable suspending the arrangement may function as the coupling element.

In a further aspect, the invention may provide an area lighting system comprising a plurality of streetlight luminaire arrangements as described herein, especially configured for illuminating at least part of an area. In yet a further aspect, the invention may provide an area lighting system comprising (a) an area, and (b) a plurality of streetlight luminaire arrangements as described herein. Especially, in embodiments, the plurality of streetlight luminaire arrangements may be configured in an array. More especially, in embodiments, the plurality of streetlight luminaire arrangements may be configured to illuminate at least part of the area with device light, such as essentially all of the area. Hence, in specific embodiments, the invention may provide an area lighting system comprising (a) an area, and (b) a plurality of streetlight luminaire arrangements as described herein, wherein the plurality of streetlight luminaire arrangements may be configured in an array and may be configured to illuminate at least part of the area with device light.

Such an area lighting system may be beneficial as the implementation of streetlight luminaire arrangements as described herein in an area lighting system may provide an improved wireless network in the respective area. Hence, by implementing streetlight luminaire arrangements as described herein in an area lighting system wireless connection may become better and more widely accessible.

In embodiments, the area of the area lighting system may comprise an indoor area. In other embodiments, especially, the area of the area lighting system may comprise an outdoor area, see also further below. Especially, in embodiments, the area may comprise an elongated area.

The streetlight luminaire arrangements may be configured to illuminate at least part of the area with device light. Hence, in some embodiments, the area may (still) comprise one or more non-illuminated (or dark) areas. However, in other embodiments, the streetlight luminaire arrangements may be configured to illuminate the whole area (to at least some degree, i.e., there may be spots more intensely illuminated than other spots).

Further, in embodiments, the area lighting system may also comprise a control system. Especially, the control system may be configured to control the plurality of streetlight luminaire arrangements. For example, in embodiments, the control system may control the light generating devices of the plurality of streetlight luminaire arrangements, i.e., turn the light generating devices on or off. The control system may also, in embodiments, control the antenna system and/or the radio system, i.e., the control system may control the transmission and/or reception of wireless signals among the streetlight luminaire arrangements and other devices (such as mobile phones or transmission towers).

Similarly, in yet a further aspect, the invention may provide an area lighting system comprising (a) an area, and (b) a plurality of streetlights as described herein. Especially, in embodiments, the plurality of streetlights may be configured in an array. More especially, in embodiments, the plurality of streetlights may be configured to illuminate at least part of the area with device light, such as essentially all of the area. Further embodiments for such an area lighting system may correspond to embodiments described for the area lighting system comprising an area and a plurality of streetlight luminaire arrangements above. Hence, in specific embodiments, the invention may provide an area lighting system comprising (a) an area, and (b) a plurality of streetlight luminaire arrangements as described herein, wherein the plurality of streetlight luminaire arrangements may be configured in an array and may be configured to illuminate at least part of the area with device light.

Further, in specific embodiments, the area (of the area lighting system) may comprise an outdoor area. Especially, in embodiments, the area may comprise an elongated area, i.e., the area may be longer than it is wide (such as e.g. a highway). In embodiments, especially, the area may be selected from the group of a street, a railway, a highway, an alley, an avenue, a bike path, a waterway, a (sports) field, a race track, a parking lot, an outdoor industrial and logistics area, and a landing strip.

Further, in embodiments, the area lighting system may comprise a plurality of second streetlight luminaire arrangements. Especially, in embodiments, the plurality of second streetlights luminaire arrangements may comprise the same light generating devices (as the (first) streetlight luminaire arrangements) as described above. However, in such embodiments, the plurality of second streetlight luminaire arrangements may not comprise the antenna system and the radio system. Or in other words, in such embodiments, the plurality of second streetlight luminaire arrangements may be free from the antenna system and the radio system. Further, in embodiments, along the area, the plurality of (first) streetlight luminaire arrangements and the plurality of second streetlight luminaire arrangements may be configured in a repetitive pattern based on a set. Especially, in such embodiments, the set may comprise at least one (first) streetlight luminaire arrangement and at least one second streetlight luminaire arrangement. For example, the plurality of (first) streetlight luminaire arrangements and the plurality of second streetlight luminaire arrangements may be configured in an alternating (or “interdigitated”) repetitive pattern. Hence, in specific embodiments, the area lighting system may comprise a plurality of second streetlight luminaire arrangements, wherein the plurality of second streetlight luminaire arrangements may comprise the same light generating devices, but may not comprise the antenna system and the radio system, wherein along the area, the plurality of streetlight luminaire arrangements and the plurality of second streetlight luminaire arrangements may be configured in a repetitive pattern based on a set comprising at least one streetlight luminaire arrangement and at least one second streetlight luminaire arrangement.

Such embodiments may be beneficial as wireless connectivity may be provided with a more efficient connectivity-cost ratio. The second streetlight luminaire arrangements may especially comprise conventional streetlight luminaire arrangements. Thus, the second streetlight luminaire arrangements may comprise (essentially) no components for wireless connectivity and may therefore be relatively cheap. On the other hand, the (first) streetlight luminaire arrangements as described here may comprise the components for wireless connectivity. By alternating the two types of streetlight luminaire arrangements (such as in a repetitive pattern, see below), a wireless network may be created with a cost efficient approach. Especially, with such embodiments, sufficient wireless connectivity may be provided without having to place a streetlight luminaire arrangement, comprising (additional and possibly expensive) components for wireless connectivity (i.e., a radio system and an antenna system), at every position in the area lighting system.

Thus, in embodiments, the area street lighting system may comprise two types of streetlight luminaire arrangements, i.e., (first) streetlight luminaire arrangements and second streetlight luminaire arrangements. As such, the area street lighting system may thus comprise two types of streetlights. Especially, the area street lighting system may comprise a plurality of (first) streetlights comprising the antenna system and radio system, and a plurality of (second) streetlights not comprising the antenna system and radio system.

In embodiments, the two different types of streetlight luminaire arrangements (and hence streetlights) may be configured in a repetitive pattern along the area. Especially, in embodiments, the plurality of (first) streetlight luminaire arrangements and the plurality of second streetlight luminaire arrangements may be configured in an alternating (or “interdigitated”) repetitive pattern. In embodiments, the repetitive pattern may, for example, comprise a repetition of one of the following repetition motifs: [ABAB]ᵢ, [AABBAABB]ᵢ, [ABBABB]ᵢ, [ABBBAB]ᵢ, [ABBBAAB]ᵢ. Herein, A may indicate one of the two types of streetlight luminaire arrangements, whereas B may indicate the other of the two types of streetlight luminaire arrangements, and i may indicate the number of repetitions, e.g., i may be selected from 1, 2, 3 . . . , 10000.

As the examples of repetition motifs illustrate, the repetitive pattern may especially, in embodiments, be based on a set comprising at least one (first) streetlight luminaire arrangement and at least one second streetlight luminaire arrangement. For example, in embodiments, the repetitive pattern may be based on a set comprising one (first) streetlight luminaire arrangement and three second streetlight luminaire arrangements. Further, in such embodiments, the repetitive pattern may for example be a repetition of the repetition motif BABB, where A indicates a (first) streetlight luminaire arrangement and B indicated a second streetlight luminaire arrangement. The skilled person will appreciate that other repetition motifs aside from the above mentioned examples may be possible as well.

In embodiments, the plurality of second streetlight luminaire arrangements may provide light having the same distribution as the (first) streetlight luminaire arrangements, i.e., having an optical axis in an equivalent direction. However, in other embodiments, the second streetlight luminaire arrangements may provide light having a different distribution from the (first) streetlight luminaire arrangements, i.e., having a differently directed optical axis.

In a specific example, in embodiments, the plurality of (first) streetlight luminaire arrangements may be configured in a zig-zag arrangement along the area.

Such a zig-zag arrangement may be beneficial in conventional streetlight systems which (often) comprise streetlights at opposite sides of an area, such as a road. In dependency of the width of the road, the desired light level of illuminated road surface, the signal range/strength of the radio and antenna's, the pitch at which the street lights are positioned along the road (or the number of streetlights not equipped with radio and antenna's between streetlights having radio and antenna's and which thus can be skipped/ignored with respect to communication), etcetera . . . , the first mutual angle α between the antenna boresight axes A_{M} of the streetlight for being communicatively coupled to streetlight positioned diagonally opposite to said streetlight could be in a relatively acute angle range of 55-88°, such as 55-75° or 75-88°, or in a relatively obtuse angle range of 92-160°, such as 92-120° or 120-160°. Especially for the obtuse angle ranges, by implementing the herein described (first) streetlight luminaire arrangements in a zig-zag arrangement in a conventional streetlight system, wireless connectivity may be provided to the streetlight system, without the need to replace every conventional streetlight luminaire arrangement with a streetlight luminaire arrangement with wireless connectivity components. Hence, a zig-zag arrangement along an area may provide wireless connectivity in (existing) streetlight systems with relatively low cost and effort. Furthermore, a zig-zag arrangement may provide the additional benefit of improved wireless connectivity as wireless signals may be maneuvered around obstacles, such as trees or road signs. The zig-zag arrangement may be especially beneficial in providing wireless connectivity at intersections, i.e., to connect roads oriented perpendicular to each other.

In embodiments, the plurality of (first) streetlight luminaire arrangements may be subdivided into subsets of two. Especially, in embodiments, each subset of two (first) streetlight luminaire arrangements may be configured in opposite directions, such that a first antenna module of one of the two (first) streetlight luminaire arrangements may essentially face a second antenna module of the other one of the two (first) streetlight luminaire arrangements. Hence, in such embodiments, as the antenna modules may be configured in a first mutual angle (α) relative to each other (and hence also an angle equal to half a relative to the center axis (A₁₂)), the center axes (A₁₂) of the two streetlight luminaire arrangements may be parallel, but offset by a distance (d). In embodiments, by repeating such subsets of two (first) streetlight luminaire arrangements as described here along the area, the plurality of (first) streetlight luminaire arrangements may form a zig-zag arrangement along the area.

The distance (d) between the center axes (A₁₂) of two (first) streetlight luminaire arrangements of a subset may be selected from the range of 10-200 m, such as from the range of 20-150 m, like from the range of 50-100 m. Especially, in embodiments, the distance (d) may be chosen and the first mutual angle (α) may be chosen such, that the two (first) streetlight luminaire arrangements may provide wireless connectivity among each other. More especially, in embodiments, the distance (d) may be chosen and the first mutual angle (α) may be chosen taking into account (also) a diagonal (or absolute) distance (d2) between positions of the two (first) streetlight luminaire arrangements. Hence, in embodiments, the two (first) streetlight luminaire arrangements may be configured such, that sin (α/2)=d/d2. By configuring multiple sets of two (first) streetlight luminaire arrangements along an area such, that for each set sin (α/2)=d/d2 may be satisfied, may provide a zig-zag arrangement of (first) streetlight luminaire arrangements along the area. For streetlight distances in the range of 20-200 m on either side of the road, and streetlights on one side of the road a half phase shifted with respect to the streetlight on the opposite side of the road (zig-zag arrangement of the streetlights), the mutual first angle α between the boresight axes A_{M} of the antenna's is typically in the range of 55-160° for a streetlight one (first) side of the road to be communicatively coupled with streetlight on the other (second) side of the road. This typically is suitable for streetlights wherein the number of antenna's comprised in the streetlight is exactly two, no more and no less. The range of 88-90° being excluded or disclaimed to preclude an incident anticipation.

In embodiments, the distance (d) between the center axes (A₁₂) of one (first) streetlight luminaires to a neighboring (first) streetlight luminaire arrangement may be substantially equal for all (first) streetlight luminaire arrangements. However, in other embodiments, the distance (d) between the center axes (A₁₂) of one (first) streetlight luminaires to a neighboring (first) streetlight luminaire arrangement may be different for the different (first) streetlight luminaire arrangements.

Further, in embodiments, each set (i.e. not subset) may comprise n₁ streetlight luminaire arrangements and n₂ second streetlight luminaire arrangements. Especially, in embodiments, there may be between three and ten streetlight luminaire arrangements in total in each set, i.e., 3≤n₁+n₂≤10. Especially, in embodiments, (n₁+n₂)≥2, such as (n₁+n₂)≥5, like (n₁+n₂)≥7. More especially, in embodiments, (n₁+n₂)≤12, such as (n₁+n₂)≤10, like (n₁+n₂)≤8. Further, in embodiments, there may be more second streetlight luminaire arrangements than (first) streetlight luminaire arrangements, especially, 3≤n₂/n₁≤5. Hence, in embodiments, there may be at least two second streetlight luminaire arrangement for every one (first) streetlight luminaire arrangement, such as at least three second streetlight luminaire arrangements for every one (first) streetlight luminaire arrangement, including at least four second streetlight luminaire arrangements for every one (first) streetlight luminaire arrangement. However, in embodiments, there may be at most six second streetlight luminaire arrangements for every one (first) streetlight luminaire arrangement, such as at most five second streetlight luminaire arrangements for every one (first) streetlight luminaire arrangement. Hence, in specific embodiments, each set may comprise n₁ streetlight luminaire arrangements and n₂ second streetlight luminaire arrangements, wherein 3≤n₁+n₂≤10, and wherein 3≤n₂/n₁≤5.

In a yet further aspect, the invention may provide a method of conveying a radio frequency (RF) signal over a distance with the area lighting system as described above. Especially, in embodiments, the method may comprise providing an RF signal to one or more of the streetlight luminaire arrangements at a first position relative to the area. Subsequently, in embodiments, the method may comprise conveying the RF signal via a plurality of (intermediate) streetlight luminaire arrangements to a second position relative to the area. Hence, in specific embodiments, the invention may provide a method of conveying an RF signal over a distance with the area lighting system as described herein, wherein the method may comprise: providing an RF signal to one or more of the streetlight luminaire arrangements at a first position relative to the area, and conveying the RF signal via a plurality of streetlight luminaire arrangements to a second position relative to the area.

In embodiments, the method may comprise providing a radio frequency signal. Especially, the method may comprise providing a radio frequency signal to a streetlight luminaire arrangement configured at a first position relative to the area (as described above) through wireless transmission. Subsequently, the method may, in embodiments, comprise conveying said radio frequency signal from one streetlight luminaire arrangement (at the first position) via another streetlight luminaire arrangement to a second position relative to the area through wireless transmission. Especially, in embodiments, the method may comprise conveying said radio frequency signal from one streetlight luminaire arrangement (at the first position) via a plurality of other (intermediate) streetlight luminaire arrangement to a second position relative to the area through wireless transmission.

In embodiments, the present disclosure (also) provides a luminaire with an “add-on” or additional element, compared to conventional luminaires, for wireless communications. Conventional luminaires may comprise the first enclosure as described herein. The additional element is formed from a second enclosure that may be configured on top of a conventional luminaire, i.e., the first enclosure (which holds the light source). The second enclosure may further enclose additional components for the add-on element, especially at least a radio system and an antenna system.

In yet a further aspect, the invention provides a method for (late-stage) arranging a second enclosure comprising at least the antenna system, and the radio system, to a first enclosure. The first enclosure may be the first enclosure of an earlier produced luminaire, e.g. for street lighting, but not yet installed, or may be the first enclosure of an already installed luminaire, e.g. for street lighting. The arranging may include attaching the second enclosure to the first enclosure.

The term “light source” may in principle relate to any light source known in the art. It may be a conventional (tungsten) light bulb, a low pressure mercury lamp, a high pressure mercury lamp, a fluorescent lamp, an LED (light emissive diode). In a specific embodiment, the light source comprises a solid state LED light source (such as an LED or laser diode (or “diode laser”)). The term “light source” may also relate to a plurality of light sources, such as 2-2000 (solid state) LED light sources. Hence, the term LED may also refer to a plurality of LEDs. Further, the term “light source” may in embodiments also refer to a so-called chips-on-board (COB) light source. The term “COB” especially refers to LED chips in the form of a semiconductor chip that is neither encased nor connected but directly mounted onto a substrate, such as a PCB. Hence, a plurality of light emitting semiconductor light source may be configured on the same substrate. In embodiments, a COB is a multi LED chip configured together as a single lighting module.

The term “light source” may refer to a semiconductor light-emitting device, such as a light emitting diode (LEDs), a resonant cavity light emitting diode (RCLED), a vertical cavity laser diode (VCSELs), an edge emitting laser, etc. . . . . The term “light source” may also refer to an organic light-emitting diode (OLED), such as a passive-matrix (PMOLED) or an active-matrix (AMOLED). In a specific embodiment, the light source comprises a solid-state light source (such as an LED or laser diode). In an embodiment, the light source comprises an LED (light emitting diode). The terms “light source” or “solid state light source” may also refer to a superluminescent diode (SLED).

In embodiments, the light source may comprise one or more micro-optical elements (array of micro lenses) downstream of a single solid-state light source, such as an LED, or downstream of a plurality of solid-state light sources (i.e. e.g. shared by multiple LEDs). In embodiments, the light source may comprise an LED with on-chip optics. In embodiments, the light source comprises pixelated single LEDs (with or without optics) (offering in embodiments on-chip beam steering).

The light source may especially be configured to generate light source light having an optical axis (O), (a beam shape,) and a spectral power distribution. The light source light may in embodiments comprise one or more bands, having band widths as known for lasers. The term “light source” may (thus) refer to a light generating element as such, like e.g. a solid state light source, or e.g. to a package of the light generating element, such as a solid state light source, and one or more of a luminescent material comprising element and (other) optics, like a lens, a collimator. A light converter element (“converter element” or “converter”) may comprise a luminescent material comprising element. For instance, a solid state light source as such, like a blue LED, is a light source. A combination of a solid state light source (as light generating element) and a light converter element, such as a blue LED and a light converter element, optically coupled to the solid state light source, may also be a light source (but may also be indicated as light generating device). Hence, a white LED is a light source (but may e.g. also be indicated as (white) light generating device).

The term “light source” herein may also refer to a light source comprising a solid state light source, such as an LED or a laser diode or a superluminescent diode. The term “light source” may (thus) in embodiments also refer to a light source that is (also) based on conversion of light, such as a light source in combination with a luminescent converter material. Hence, the term “light source” may also refer to a combination of an LED with a luminescent material configured to convert at least part of the LED radiation, or to a combination of a (diode) laser with a luminescent material configured to convert at least part of the (diode) laser radiation. In embodiments, the term “light source” may also refer to a combination of a light source, like an LED, and an optical filter, which may change the spectral power distribution of the light generated by the light source. Especially, the term “light generating device” may be used to address a light source and further (optical components), like an optical filter and/or a beam shaping element, etc. The term “solid state light source”, or “solid state material light source”, and similar terms, may especially refer to semiconductor light sources, such as a light emitting diode (LED), a diode laser, or a superluminescent diode.

The term “white light”, and similar terms, herein, are known to the person skilled in the art. It may especially relate to light having a correlated color temperature (CCT) between about 1800 K and 20000 K, such as between 2000 and 20000 K, especially 2700-20000 K, for general lighting especially in the range of about 2000-7000 K, such as in the range of 2700 K and 6500 K. Yet further, in embodiments the correlated color temperature (CCT) is especially within about 15 SDCM (standard deviation of color matching) from the BBL (black body locus), especially within about 10 SDCM from the BBL, even more especially within about 5 SDCM from the BBL.

The term “controlling” and similar terms especially refer at least to determining the behavior or supervising the running of an element. Hence, herein “controlling” and similar terms may e.g. refer to imposing behavior to the element (determining the behavior or supervising the running of an element), etc., such as e.g. measuring, displaying, actuating, opening, shifting, changing temperature, etc. Beyond that, the term “controlling” and similar terms may additionally include monitoring. Hence, the term “controlling” and similar terms may include imposing behavior on an element and also imposing behavior on an element and monitoring the element. The controlling of the element can be done with a control system, which may also be indicated as “controller”. The control system and the element may thus at least temporarily, or permanently, functionally be coupled. The element may comprise the control system. In embodiments, the control system and element may not be physically coupled. Control can be done via wired and/or wireless control. The term “control system” may also refer to a plurality of different control systems, which especially are functionally coupled, and of which e.g. one control system may be a master control system and one or more others may be slave control systems. A control system may comprise or may be functionally coupled to a user interface.

The control system may also be configured to receive and execute instructions from a remote control. In embodiments, the control system may be controlled via an App on a device, such as a portable device, like a Smartphone or I-phone, a tablet, etc. The device is thus not necessarily coupled to the lighting system, but may be (temporarily) functionally coupled to the lighting system.

Hence, in embodiments the control system may (also) be configured to be controlled by an App on a remote device. In such embodiments the control system of the lighting system may be a slave control system or control in a slave mode. For instance, the lighting system may be identifiable with a code, especially a unique code for the respective lighting system. The control system of the streetlight system may be configured to be controlled by an external control system which has access to the streetlight system on the basis of knowledge (input by a user interface of with an optical sensor (e.g. QR code reader) of the (unique) code. The streetlight system may also comprise means for communicating with other systems or devices, such as on the basis of millimeter wave radio frequencies or another wireless technology.

The system, or apparatus, or device may execute an action in a “mode” or “operation mode” or “mode of operation” or “operational mode”. The term “operational mode may also be indicated as “controlling mode”. Likewise, in a method an action or stage, or step may be executed in a “mode” or “operation mode” or “mode of operation” or “operational mode”. This does not exclude that the system, or apparatus, or device may also be adapted for providing another controlling mode, or a plurality of other controlling modes. Likewise, this may not exclude that before executing the mode and/or after executing the mode one or more other modes may be executed.

However, in embodiments a control system may be available, that is adapted to provide at least the controlling mode. Would other modes be available, the choice of such modes may especially be executed via a user interface, though other options, like executing a mode in dependence of a sensor signal or a (time) scheme, may also be possible. The operation mode may in embodiments also refer to a system, or apparatus, or device, which can only operate in a single operation mode (i.e. “on”, without further tunability).

Hence, in embodiments, the control system may control in dependence of one or more of an input signal of a user interface, a sensor signal (of a sensor), and a timer. The term “timer” may refer to a clock and/or a predetermined time scheme.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1A-D schematically depicts embodiments of the streetlight luminaire arrangement 1000;

FIG. 2A-B schematically depicts embodiments of the streetlight 1200;

FIG. 3 schematically depicts some further details of the antenna module 610; and

FIG. 4A-B further schematically depicts an embodiment of an area lighting system 2000.

The schematic drawings are not necessarily to scale.

### DETAILED DESCRIPTION OF THE EMBODIMENTS

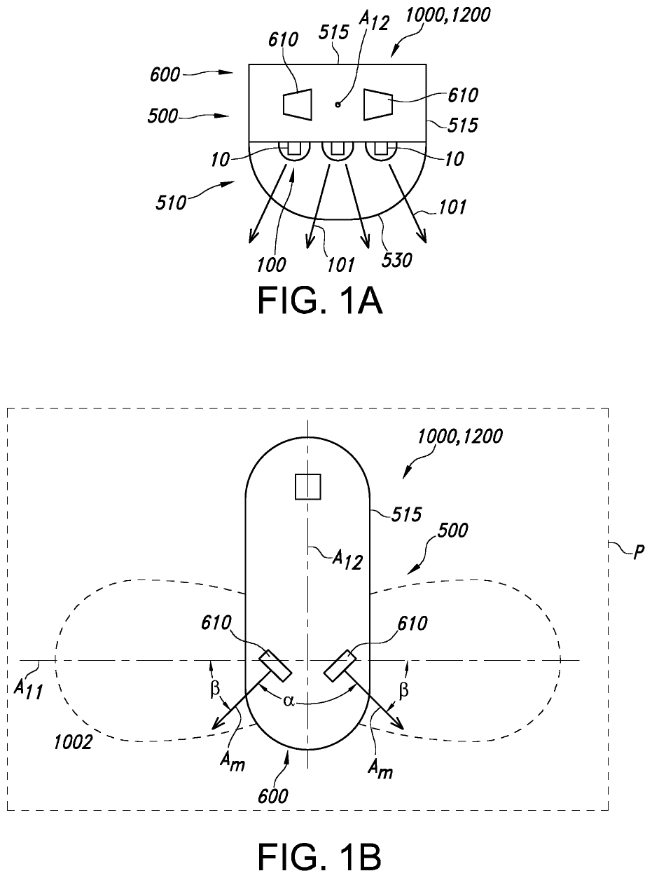

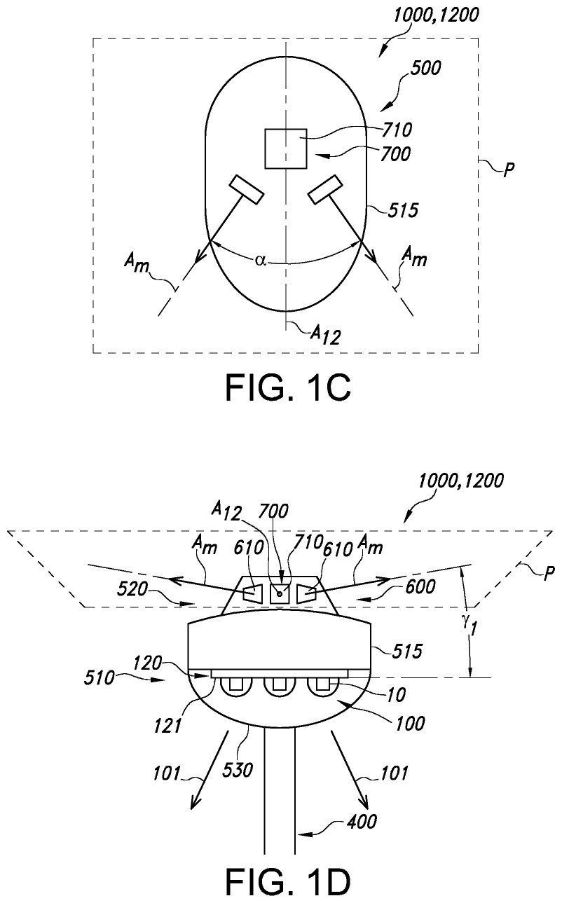

FIG. 1 schematically depicts some embodiments of a streetlight luminaire arrangement 1000 comprising a housing arrangement 500, a light generating device 100, an antenna system 600, and a radio system 700.

FIG. 1A especially schematically depicts a cross-sectional view of the streetlight luminaire arrangement 1000. In embodiments, the light generating device 100 may comprise a solid state light source 10. Especially, the light generating device 100 (especially the solid state light source 10) may be configured to generate device light 101. Especially, the light generating device 100 may be configured to generate device light 101 for illuminating an (outdoor) area 5. Therefore, in specific embodiments, the light generating device 100 may be configured to generate (at least) visible device light 101.

Further, in embodiments, the housing arrangement 500 may comprise a first enclosure 510. The light generating device 100 may especially, in embodiments, be at least partially enclosed by the housing arrangement 500. As depicted in FIG. 1A and FIG. 1B, in embodiments, the light generating device 100 may essentially be fully enclosed by the housing arrangement 500, especially by the first enclosure 510.

Yet further, in embodiments, the radio system 700 may comprise a radio unit 710. In such embodiments, the radio unit 710 may especially be communicatively coupled to the antenna system 600. Especially, in embodiments, the radio unit 710 may be configured to (a) control the transmission of wireless signals transmitted by the antenna system 600 and/or (b) process wireless signals received by the antenna system 600.

The radio system 700 and the antenna system 600 may, in embodiments, be at least partly enclosed by the housing arrangement 500. Especially, in embodiments, as depicted here in FIG. 1, the radio system 700 and the antenna system 600 may essentially fully be enclosed by the housing arrangement 500. In other embodiments, not depicted here, at least part of the radio system 700 and/or the antenna system 600 may protrude through the housing arrangement 500.

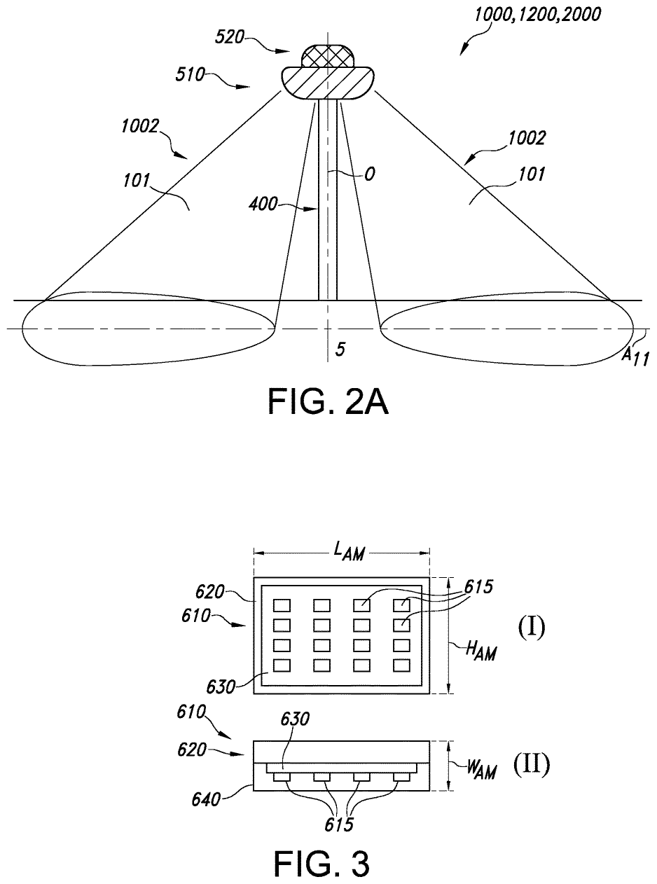

Further, the antenna system 600 may be configured to transmit and/or receive wireless signals, especially to transmit wireless signals, or especially to receive wireless signals. Therefore, in embodiments, the antenna system 600 may comprise two antenna modules 610. Especially, the two antenna modules 610 may both be configured for transmitting and/or receiving the wireless signals. In embodiments, the antenna modules 610 may each comprise an antenna boresight axis A_{M}. The antenna boresight axes A_{M} of the two antenna modules 610 may have a first mutual angle α. In embodiments, the first mutual angle α may especially be selected from the range of 55-88°. Further, in embodiments, the antenna boresight axes A_{M} may define a plane P, see FIG. 2B. Especially, in embodiments, the antenna boresight axes A_{M} may extend in the plane P. More especially, a boresight axis may herein refer to an imaginary line along which maximum gain (or “maximum radiated power”) of the antenna module 610 is achieved.

Herein, reference A₁₁ may refer to an elongation axis of the (outdoor) area 5 to be illuminated. Further, reference β may refer to a second mutual angle between the elongation axis A₁₁ and the boresight axes A_{M}. Especially, in embodiments, the second mutual angle β may be selected from the range of 10-47°, such as from the range of 15-25° or 30-40°. Yet further, reference A₁₂ may refer to a center axis of the streetlight luminaire arrangement 1000. The center axis A₁₂ may especially be defined in the plane P, such that the center axis A₁₂ may provide an averaged axis of the two boresight axes (A_{M}) together.

FIGS. 1B and 1C schematically depict cross-sectional top views of the streetlight luminaire arrangement. Herein FIG. 1B may especially also depict a cross-sectional distribution of a beam 1002 of device light 101. Especially, as depicted here, the cross-sectional distribution of the beam 1002 of device light 101 may have a shape approximating a dumbbell shape.

Further, in specific embodiments, the first mutual angle α may be selected from the range of 55-75°. However, in other specific embodiments, the first mutual angle α may be selected from the range of 75-88°.

Additionally, in embodiments such as depicted in FIG. 1D, the streetlight luminaire arrangement 1000 may comprise a second enclosure 520. In embodiments, the second enclosure 520 may be functionally coupled to the first enclosure 510. Especially, the second enclosure 520 may be physically attached, such as glued or bolted, to the first enclosure 510. Further, in embodiments, the second enclosure 520 may at least partially enclose the antenna system 600 and the radio system 700. In embodiments, such as depicted here, the second enclosure 520 may be arranged on top of the first enclosure 510. Further, the second enclosure 520 may cover at least part of the first enclosure 510. In some embodiments, not depicted here, the second enclosure 520 may essentially fully cover the first enclosure 510.

In embodiments, such as depicted in FIG. 1, the first enclosure 510 may have a ‘cobra-head’ shape. However, other shapes may be possible as well. Therefore, in embodiments, the first enclosure 510 may especially comprise one or more walls 515. Further, in embodiments, the first enclosure may comprise a light exit window 530 transmissive for at least part of the device light 101. Especially, the one or more walls 515 and the light exit window 530 may form the first enclosure 510. As illustrated here, in embodiments, the light generating device 101 may be (at least partially) configured between the one or more walls 515 and the light exit window 530.

Further, as depicted in FIG. 1D, the streetlight luminaire arrangement may (also) comprise a printed circuit board (PCB) 120. In embodiments, the PCB 120 may comprise a first face 121. Especially, in embodiments, the solid state light source 10 may be functionally coupled to the first face 121 of the PCB 120. More especially, as depicted here, one or more (such as three) solid state light sources 10 may be functionally coupled to the first face 121 of the PCB 120. Further, in embodiments, the antenna boresight axes A_{M} may have a first angle γ₁ with the first face 121 of the PCB 120. Especially, in embodiments, the first angle γ₁ may be selected from the range of 0-25°.

In FIG. 1D, the arrows indicating the antenna boresight axes A_{M} are drawn sideways and slightly angled for visual purposes. The antenna boresight axes A_{M} may especially extend toward the reader. Hence, for the same visual purposes, the plane P is drawn in perspective and may hence especially be a plane perpendicular to the sheet, i.e., may extend to the reader.

FIG. 2 schematically depicts an embodiment of a streetlight 1200, comprising the streetlight luminaire arrangement 1000 as described herein and a pole 400. Especially, in embodiments, the streetlight luminaire arrangement 1000 may be functionally coupled to the pole 400. Herein functionally coupled may refer to one or more of physically coupled, mechanically coupled, and electrically coupled.

As depicted in FIGS. 2A and 2B, in embodiments, the streetlight luminaire arrangement 1000 may be configured to generate a beam 1002 of device light 101. Especially, in embodiments, the beam 1002 of device light 101 may have an optical axis O. The optical axis O may be defined as an axis along which the device light 101 propagates during operation of the light generating device 100. The beam 1002 of device light 101 may, in embodiments such as depicted in FIG. 2A especially have a cross-sectional distribution with a shape approximating a dumbbell shape. Or in other words, the beam 1002 of device light 101 may, in embodiments such as depicted in FIG. 2A especially have a cross-sectional distribution with a shape approximating two mirrored ovoid shapes. Further, in other embodiments, such as depicted in 2B especially subfigure IV, the beam 1002 of device light 101 may also have a cross-sectional distribution with a shape approximating a circle. Yet further, in other embodiments, the beam 1002 of device light may even have a completely different shape, such as depicted in FIG. 2B subfigure II.

Further, as described above, the antenna boresight axes A_{M} may be configured in the plane P. Especially, in embodiments, the optical axis O may have a second angle γ₂ with a normal N to the plane P, see especially FIG. 2B subfigure I. In embodiments, the second angle 72 may be selected from the range of 0-25°. Hence, as depicted in FIG. 2B subfigure III, the second angle γ₂ may be zero degrees, i.e., the optical axis (O) and the normal (N) of the plane (P) may essentially coincide.

Furthermore, the invention may provide a streetlight 1200 comprising the streetlight luminaire arrangement 1000 as described herein and a pole 400, such as depicted here in FIGS. 2A and 2B. Especially, in embodiments, the streetlight luminaire arrangement 1000 may be functionally coupled to the pole 400. Such a streetlight 1200 may especially be positioned in the area 5.

In embodiments, the streetlight 1200 may further comprise a coupling element 200. Especially, the coupling element 200 may be configured to functionally couple, such as physically and/or electrically couple, the streetlight luminaire arrangement 1000 to the pole 400. The streetlight luminaire arrangement 1000 may especially comprise a first side 1010 and a second side 1020. The first side 1010 and the second side 1020 of the streetlight luminaire arrangement 1000 may especially define a dimension of the streetlight luminaire arrangement 1000. For example, such as depicted in FIG. 2B subfigure I the first side 1010 and the second side 1020 may define a length of the streetlight luminaire arrangement 1000. In another example, such as depicted in FIG. 2B subfigure III, the first side 1010 and the second side 1020 may define a height of the streetlight luminaire arrangement 1000. In embodiments, especially, the coupling element 200 may be configured closer to one of the sides 1010,1020 and the antenna modules 610 may be configured closer to the other one of the sides 1010,1020, such as depicted here in FIG. 2B. However, in other embodiments, the coupling element 200 may be configured closer to both sides 1010,1020 than the antenna modules 610.

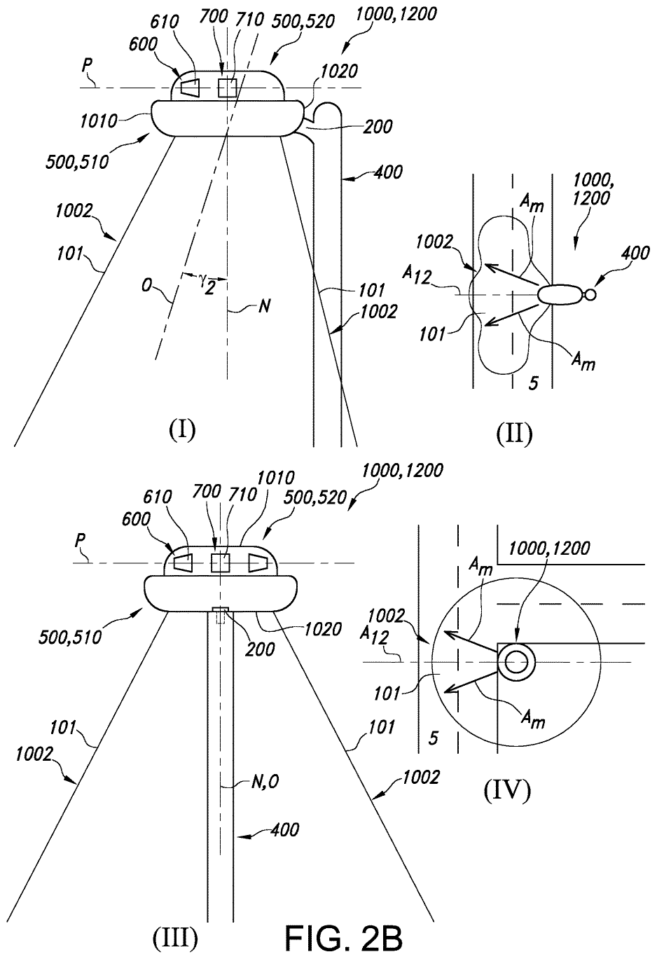

FIG. 3 schematically depicts some further details of an antenna module 610. Especially, in embodiments, each antenna module 610 may comprise a plurality of (radio frequency) antennas 615. Especially, the plurality of (RF) antennas 615 may be configured in a planar arrangement. In embodiments, the plurality of (RF) antennas 615 may be configured in one or more 2D arrays. As depicted here, in embodiments, the planar arrangement may especially comprise an n*m array, e.g. a 4×4 array.

Further, in embodiments, each antenna module 610 may have a length L_{AM}, a width W_{AM}, and a height H_{AM}. In embodiments, the antenna module length L_{AM} may be defined in a plane parallel to the plane P. Further, in embodiments, the antenna module width W_{AM} may be defined in a plane parallel to the plane P. Yet further, in embodiments, the antenna module height H_{AM} may be defined in a plane perpendicular to the plane P. Yet further, in embodiments, each antenna module 610 may comprise a backplate 620, a plurality of (RF) antennas 615, and a cover 640. Especially, in embodiments, the plurality of antennas 615 may be configured on the backplate 620. More especially, in specific embodiments, the plurality of antennas 615 may be configured on an antenna printed circuit board (PCB) 630. In such embodiments, especially, the antenna PCB 630 may be configured on the backplate 620.

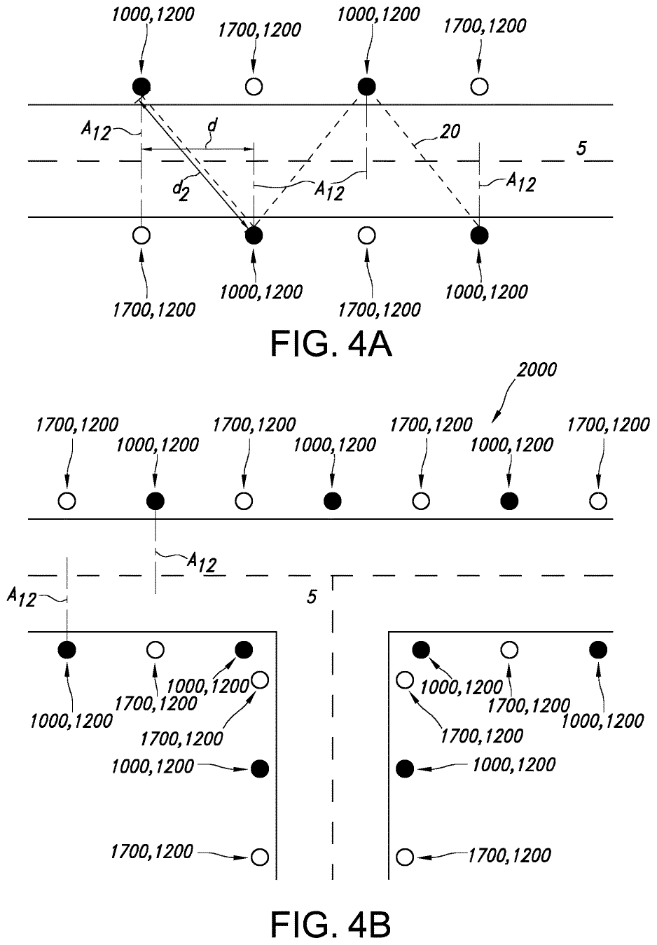

FIG. 4 schematically depicts an area lighting system 2000 comprising an area 5 and a plurality of streetlight luminaire arrangements 1000. Especially, in embodiments, the plurality of streetlight luminaire arrangements 1000 may be configured in an array 1500. Further, in embodiments, the plurality of streetlight luminaire arrangements may be configured to illuminate at least part of the area 5 with device light 101.

In embodiments, the area 5 of the area lighting system 2000 may comprise an outdoor area 5. Especially, in embodiments, the area 5 may be selected from the group of a street (such as depicted here in FIG. 4B), a railway, a highway (such as depicted here in FIG. 4A), an alley, an avenue, a bike path, a waterway, a (sports) field, a race track, a parking lot, an outdoor industrial and logistics area, and a landing strip.

Further, in embodiments, the area lighting system 2000 may comprise a plurality of second streetlight luminaire arrangements 1700. Especially, in embodiments, the plurality of second streetlight luminaire arrangements 1700 may comprise the same light generating devices 100 (as the (first) streetlight luminaire arrangements 1000), but may not comprise the antenna system 600 and the radio system 700. Further, in embodiments, as depicted here in FIGS. 4A and 4B, the plurality of (first) streetlight luminaire arrangements 1000 and the plurality of second streetlight luminaire arrangement 1700 may be configured along the area 5 in a (n alternating or interdigitated) repetitive pattern. Especially, in embodiments, the repetitive pattern may be based on a set comprising at least one streetlight luminaire arrangement 1000 and at least one second streetlight luminaire arrangement 1700. For example, as depicted here in FIG. 4B, the plurality of (first) streetlight luminaire arrangements 1000 and the plurality of second streetlight luminaire arrangements 1700 may be configured along the area 5 in a repetitive pattern of repetition motif: [ABAB]ᵢ, where A may represent one of the (first) streetlight luminaire arrangement 1000 and the second streetlight luminaire arrangement 1700, B may represent the other one, and i may represent the number of repetitions, i.e. here i=1.

As depicted in FIG. 4B, applying such a repetitive pattern of repetition motif: [ABAB]ᵢ in an two rows and where the pattern is offset by one, may result in a zig-zag pattern. Especially, in such embodiments, the plurality of (first) streetlight luminaire arrangements 1000 may be subdivided into subsets of two. Especially, in embodiments, each subset of two (first) streetlight luminaire arrangements 1000 may be configured in opposite directions, such that a first antenna module 610 of one of the two (first) streetlight luminaire arrangements may essentially face a second antenna module 610 of the other one of the two (first) streetlight luminaire arrangements 1000. Hence, especially in such embodiments, the center axes A₁₂ of the two streetlight luminaire arrangements 1000 may be parallel, but offset by a distance d. In embodiments, by repeating such subsets of two (first) streetlight luminaire arrangements 1000 as described here along the area 5, the plurality of (first) streetlight luminaire arrangements 1000 may form a zig-zag arrangement 20 along the area 5. Hence, in specific embodiments, the streetlight luminaire arrangements 1000 may be configured in a zig-zag arrangement 20 along the area 5, such as depicted in FIG. 4A. Reference d2 may especially refer to a diagonal (or absolute) distance between a set of two (first) streetlight luminaire arrangements 1000 positioned along the area 5. Hence, the zig-zag arrangement 20 may especially be achieved by positioning the (first) streetlight luminaire arrangements 1000 relative to each other such, that sin (α/2)=d/d2 may be satisfied.

Further, in embodiments, each set (of at least one streetlight luminaire arrangement 1000 and at least one second streetlight luminaire arrangement 1700) may comprise n1 streetlight luminaire arrangements 1000 and n2 second streetlight luminaire arrangements 1700. Especially, in such embodiments, 3≤n1+n2≤10. More especially, in such embodiments, 3≤n2/ n1≤5, not depicted here.

The invention may further provide a method of conveying a radio frequency (RF) signal over a distance with the area lighting system 2000 as described above. Especially, the method may, in embodiments, comprise: providing an RF signal to one or more of the streetlight luminaire arrangements 1000 at a first position relative to the area 5, and conveying the RF signal via a plurality of (intermediate) streetlight luminaire arrangements 1000 to a second position relative to the area 5.

The term “plurality” refers to two or more.

The terms “substantially” or “essentially” herein, and similar terms, will be understood by the person skilled in the art. The terms “substantially” or “essentially” may also include embodiments with “entirely”, “completely”, “all”, etc. Hence, in embodiments the adjective substantially or essentially may also be removed. Where applicable, the term “substantially” or the term “essentially” may also relate to 90% or higher, such as 95% or higher, especially 99% or higher, even more especially 99.5% or higher, including 100%.

The term “comprise” also includes embodiments wherein the term “comprises” means “consists of”.

The term “and/or” especially relates to one or more of the items mentioned before and after “and/or”. For instance, a phrase “item 1 and/or item 2” and similar phrases may relate to one or more of item 1 and item 2. The term “comprising” may in an embodiment refer to “consisting of” but may in another embodiment also refer to “containing at least the defined species and optionally one or more other species”.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

The devices, apparatus, or systems may herein amongst others be described during operation. As will be clear to the person skilled in the art, the invention is not limited to methods of operation, or devices, apparatus, or systems in operation.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim.

Use of the verb “to comprise” and its conjugations does not exclude the presence of elements or steps other than those stated in a claim. Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

The article “a” or “an” preceding an element does not exclude the presence of a plurality of such elements.

The invention may be implemented by means of hardware comprising several distinct elements, and by means of a suitably programmed computer. In a device claim, or an apparatus claim, or a system claim, enumerating several means, several of these means may be embodied by one and the same item of hardware. The mere fact that certain measures are recited in mutually different dependent claims does not indicate that a combination of these measures cannot be used to advantage. In yet a further aspect, the invention (thus) provides a software product, which, when running on a computer is capable of bringing about (one or more embodiments of) the method as described herein.

The invention also provides a control system that may control the device, apparatus, or system, or that may execute the herein described method or process. Yet further, the invention also provides a computer program product, when running on a computer which is functionally coupled to or comprised by the device, apparatus, or system, controls one or more controllable elements of such device, apparatus, or system.

The invention further applies to a device, apparatus, or system comprising one or more of the characterizing features described in the description and/or shown in the attached drawings. The invention further pertains to a method or process comprising one or more of the characterizing features described in the description and/or shown in the attached drawings.

The various aspects discussed in this patent can be combined in order to provide additional advantages. Further, the person skilled in the art will understand that embodiments can be combined, and that also more than two embodiments can be combined. Furthermore, some of the features can form the basis for one or more divisional applications.

1. A streetlight luminaire arrangement comprising a housing arrangement, a light generating device, an antenna system, and a radio system; wherein:
the light generating device comprises a solid state light source; wherein the light generating device is configured to generate device light;
the housing arrangement comprises a first enclosure, wherein the light generating device is at least partially enclosed by the first enclosure;
the radio system comprises a radio unit, wherein the radio unit is communicatively coupled to the antenna system; wherein the antenna system and the radio system are at least partially enclosed by the housing arrangement; and
the antenna system is configured to transmit and/or receive wireless signals; wherein the antenna system comprises only two antenna modules for transmitting and/or receiving the wireless signals, wherein the antenna modules each comprise an antenna boresight axis, wherein the antenna boresight axes of the two antenna modules have a first mutual angle selected from the ranges of 55-88° or 92-160°.

2. The streetlight luminaire arrangement according to claim 1, wherein the first mutual angle is selected from the range of 75-88°.

3. The streetlight luminaire arrangement according to claim 1, wherein the first mutual angle is selected from the range of 92-120°.

4. The streetlight luminaire arrangement according to claim 1, wherein the first mutual angle is selected from the range of 120-160°.

5. The streetlight luminaire arrangement according to claim 1, wherein the housing arrangement comprises a second enclosure, wherein the second enclosure is functionally coupled to the first enclosure, wherein the second enclosure at least partially encloses the antenna system and the radio system; wherein second enclosure is arranged on top of the first enclosure.

6. The streetlight luminaire arrangement according to claim 1, comprising a printed circuit board, wherein the printed circuit board comprises a first face, wherein the solid state light source is functionally coupled to first face of the printed circuit board; wherein the antenna boresight axes have a first angle with the first face selected from the range of 0-25°.

7. The streetlight luminaire arrangement according to, claim 1, wherein the streetlight luminaire arrangement is configured to generate a beam of device light, wherein the beam of device light has an optical axis, defined as an axis along which the device light propagates during operation of the light generating device, wherein the antenna boresight axes are configured in a plane, wherein the optical axis has a second angle with a normal to the plane selected from the range of 0-25°.

8. The streetlight luminaire arrangement according to claim 1, wherein each antenna module comprises a plurality of antennas configured in a planar arrangement; wherein the first enclosure comprises a light exit window being transmissive for at least part of the device light; and wherein the radio unit is configured to (a) control the transmission of wireless signals transmitted by the antenna system and/or (b) process wireless signals received by the antenna system.

9. The streetlight comprising the streetlight luminaire arrangement according to claim 1 and a pole, wherein the streetlight luminaire arrangement is functionally coupled to the pole wherein the streetlight comprises a coupling element, wherein the coupling element is configured to functionally couple the streetlight luminaire arrangement to the pole, wherein the streetlight luminaire arrangement comprises a first side and a second side, wherein the first side and the second side define a dimension of the streetlight luminaire arrangement; wherein (a) the coupling element is configured closer to one of the sides and the antenna modules are configured closer to the other one of the sides, (b) the coupling element is configured closer to both sides than the antenna modules.

10. An area lighting system comprising (a) an area, and (b) a plurality of streetlight luminaire arrangements according to claim 1, wherein the plurality of streetlight luminaire arrangements are configured in an array, and are configured to illuminate at least part of the area with device light.

11. The area lighting system according to claim 9, comprising a plurality of second streetlight luminaire arrangements, wherein the plurality of second streetlight luminaire arrangements comprise the same light generating devices, but do not comprise the antenna system and the radio system; wherein along the area, the plurality of streetlight luminaire arrangements and the plurality of second streetlight luminaire arrangements are configured in a repetitive pattern based on a set comprising at least one streetlight luminaire arrangement and at least one second streetlight luminaire arrangement.

12. The area lighting system according to claim 9, wherein the streetlight luminaire arrangements are configured in a zig-zag arrangement along the area.

13. The area lighting system according to claim 11, wherein each set comprises n1 streetlight luminaire arrangements and n2 second streetlight luminaire arrangements, wherein 3≤n1+n2≤10, and wherein 3≤n2/n1≤5.

14. A method of conveying an RF signal over a distance with the area lighting system, comprising an area and a plurality of streetlight luminaire arrangements, each of the plurality of streetlight luminaire arrangements comprising a housing arrangement, a light generating device, an antenna system, and a radio system; wherein:
the light generating device comprises a solid state light source; wherein the light generating device is configured to generate device light;
the housing arrangement comprises a first enclosure, wherein the light generating device is at least partially enclosed by the first enclosure;
the radio system comprises a radio unit, wherein the radio unit is communicatively coupled to the antenna system; wherein the antenna system and the radio system are at least partially enclosed by the housing arrangement; and
the antenna system is configured to transmit and/or receive wireless signals; wherein the antenna system comprises only two antenna modules for transmitting and/or receiving the wireless signals, wherein the antenna modules each comprise an antenna boresight axis, wherein the antenna boresight axes of the two antenna modules have a first mutual angle selected from the ranges of 55-88° or 92-160°, wherein the plurality of streetlight luminaire arrangements are configured in an array, and are configured to illuminate at least part of the area with device light, wherein the method comprises: providing an RF signal to one or more of the streetlight luminaire arrangements at a first position relative to the area, and conveying the RF signal via a plurality of streetlight luminaire arrangements to a second position relative to the area.
